(19) United States
(12) Patent Application Publication
(10) Pub. No.: US 2006/0165232 A1
(43) Pub. Date: Jul. 27, 2006

(54) Method and apparatus to encrypt video data streams

(76) Inventors: Dzevdet Burazerovic, Eindhoven (NL); Albert M.A. Ruckaert, Waalre (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,394

(22) PCT Filed: Dec. 12, 2003
(86) PCT No.: PCT/IB03/05965

§ 371 Date: Jun. 15, 2005

Related U.S. Application Data
(60) Provisional application No. 60/433,747, filed on Dec. 16, 2002.

(51) Int. Cl. H04K 1/06

(52) U.S. Cl. 380/37; 380/239; 380/250; 380/277

(57) ABSTRACT

A method and system for encrypting a video data stream, the video data stream partitioned into units based upon a type of data contained within the units. The method comprising: determining for each unit the type of data contained within the unit; and encrypting a particular unit or a portion of the particular unit based upon the type of data contained within the unit.

The present invention relates to the field of data encryption; more specifically, it relates to encrypting of video data for subsequent rendering on processor-based video systems.

With the increasing prospects for widespread use of multi-media communications through open networks, such as the Internet and wireless networks, the need for confidentially and privacy as well as controlled access will become increasingly important. Encryption of data sent over these networks has become the solution of choice.

However, as broadband contents increase, encryption at the content or service provider end and especially decryption time at the user end is either slow (low performance processor) or expensive (high performance processor) because of the burden put on the processors. The latest methods of encrypting based on video frames helps somewhat, but video frames still require encrypting very large amounts of data that will only increase as broadband content increases.

A first aspect of the present invention is a method of encrypting a video data stream, the video data stream partitioned into units based upon a type of data contained within the units comprising: determining for each unit the type of data contained within the unit; and encrypting a particular unit or a portion of the particular unit based upon the type of data contained within the unit.

A second aspect of the present invention is a method of encrypting a video data stream, the video data stream partitioned into NAL units formed from partitioned slices, each NAL unit containing either header data, intra data or inter data, comprising: determining for each NAL unit whether the NAL unit contains header data, intra data or inter data; and encrypting a particular NAL unit or a portion of the particular NAL unit based upon whether the particular NAL unit contains header data, intra data or inter data.

A third aspect of the present invention is s system for encrypting a video data stream, the video data stream partitioned into units based upon a type of data contained within the units comprising: means for determining for each unit the type of data contained within the unit; and means for encrypting a particular unit or a portion of the particular unit based upon the type of data contained within the unit.

A fourth aspect of the present invention is a system of encrypting a video data stream, the video data stream partitioned into NAL units formed from partitioned slices, each NAL unit containing either header data, intra data or inter data, comprising: means for determining for each NAL unit whether the NAL unit contains header data, intra data or inter data; and means for encrypting a particular NAL unit or a portion of the particular NAL unit based upon whether the particular NAL unit contains header data, intra data or inter data.

The features of the invention are set forth in the appended claims. The invention itself, however, will be best understood by reference to the following detailed description of an illustrative embodiment when read in conjunction with the accompanying drawings, wherein:

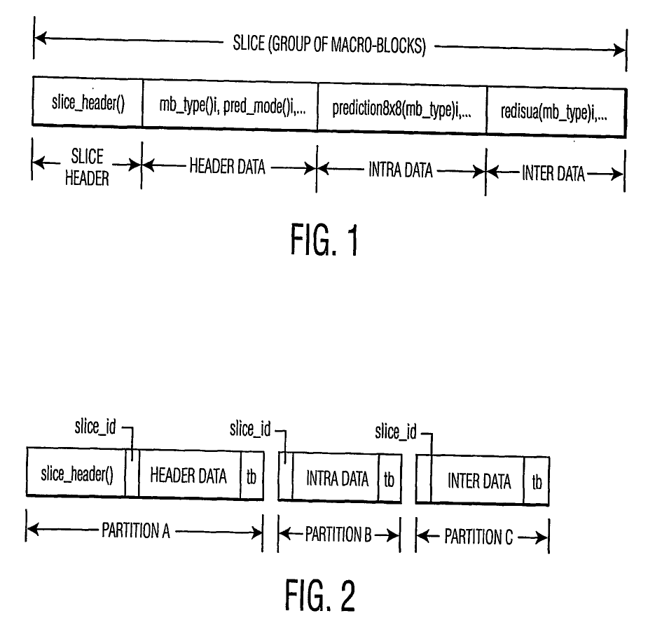

FIG. 1 is an illustration of data grouping before partitioning;

FIG. 2 is an illustration of the formation of data partitions from data groups;

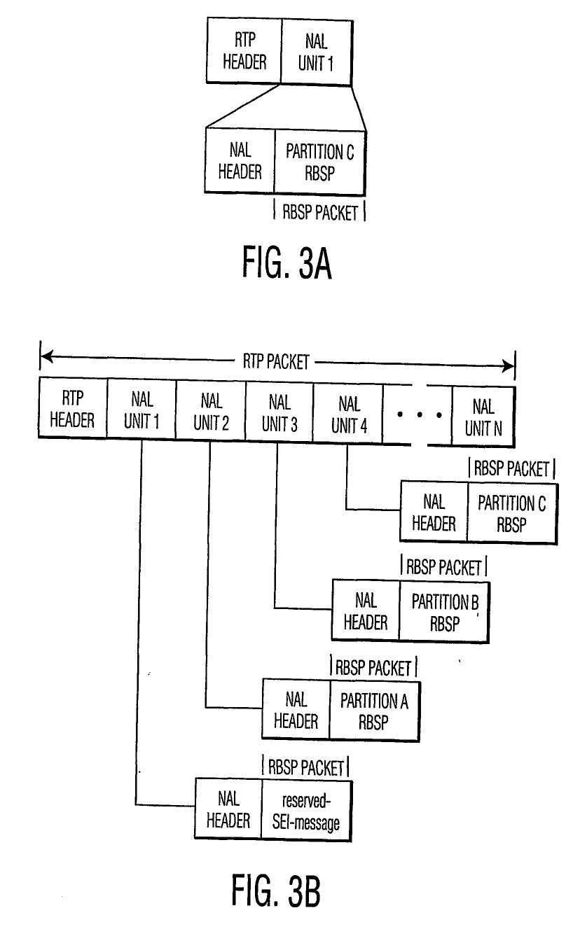

FIGS. 3A and 3B are illustrations of a RTP/NAL (network abstraction layer) unit packages;

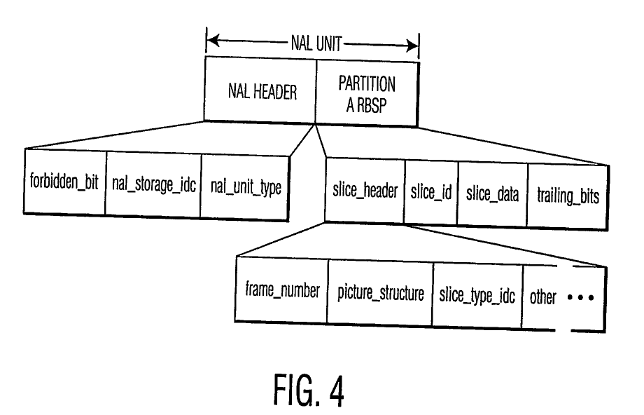

FIG. 4 is an illustration of the field structure of NAL units;

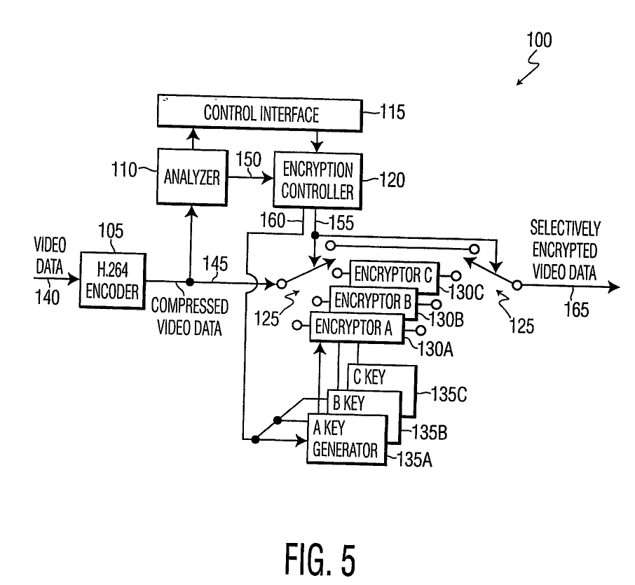

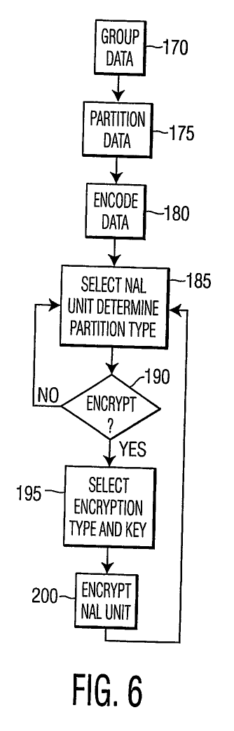

FIG. 5 is a schematic block diagram of a system for encrypting the International Telecommunications Union Telecommunications Standardization Sector (ITU-T) H.264 video data stream according to the present invention; and

FIG. 6 is a flowchart of the method steps for encrypting video data according to the present invention.

FIGS. 1 through 3A and 4 are provided as an aid to understanding the present invention and merely illustrate the ITU-T H.264 standard digital data stream structure. FIG. 3B extends the invention to a situation not presently defined in ITU-T H.264

FIG. 1 is an illustration of data grouping before partitioning. A slice is defined as an integer number of macro-blocks ordered contiguously in raster scan order within a particular slice group, which may not be contiguous within the picture. In FIG. 1 a slice includes a slice header field, a header data field, an intra data field and a inter data field. The index “i” is used to indicate the specified data corresponds to the i^{th} macro-block in the slice. Header data includes the macro-block type (syntax=mb_type( )i). Macro block types include I blocks, P blocks, B blocks, SI blocks and SP blocks, each of which has sub macro-block types not of interest to the present invention.

An I block is defined as a block coded using prediction (estimation of the value being decoded) from decoded samples within the same block. An SI block is defined as a switching I block. A P block is defined as a block coded using prediction from previously decoded reference pictures. A SP block is defined as a switching P block. A B block is defined as a predictive block. There are five predictive modes for B blocks, list 0, list 1, bi-predictive, direct and intra predictive. I and SI blocks are intra predictive blocks because the prediction is derived from decoded samples of the current decoded picture. P, SP and B blocks are inter predictive blocks because the prediction is derived from decoded samples other than the current decoded picture. Note the definition relating to I, P, B, SI and SP blocks are applicable to macro-blocks, frames, fields and pictures bearing the same designations, however in the case of macro-blocks it should be understood that different types of macro-blocks can exist within a single slice of a single picture. Moreover, even sub-blocks of a macro-block can be of different types.

The intra data field contains coded intra block (i.e. I and SI blocks) data. The inter data field contains coded inter block (i.e. P, SP and B block) data.

FIG. 2 is an illustration of the formation of data partition types from data groups. Partitioning is defined as the division of a set (i.e. the elements of the slice of FIG. 1) into subsets (i.e. the elements of the partition types of FIG. 2) such that each element of the set is in exactly one of the subsets. In FIG. 2, the slice illustrated in FIG. 1 is partitioned into three partition types. Partition type A includes a slice header field (syntax=slice_header( )), a slice ID field (syntax=slice_id), a header data field and a trailing bits field (syntax=tb). The content of the slice header field of partition type A is the content of the slice header field of the slice illustrated in FIG. 1. The slice ID field is a new field (relative to FIG. 1), which indicates which slice the partition is derived from. The contents of the partition type A header data field is the contents of the data header field of the slice illustrated in FIG. 1. The trailing bits field is a new field (relative to FIG. 1) and is used to make the number of bits in partition type A an even multiple of 8.

Partition type B includes the slice ID field described supra, an intra data field and a trailing bits field. The content of the partition type B intra data field is the content of the intra data field of the slice illustrated in FIG. 1. The trailing bits field is again used to make the number of bits in partition type B an even multiple of 8.

Partition type C includes the slice ID field described supra, an inter data field and a trailing bits field. The content of the partition type C inter data field is the content of the inter data field of the slice illustrated in FIG. 1. The trailing bits field is again used to make the number of bits in partition type C an even multiple of 8.

FIGS. 3A and 3B are illustrations of a RTP/NAL unit packages. The ITU-T H.264 standard specifies a NAL unit as a generic format for use in both packet orientated and bit-stream systems. A NAL unit is constructed by concatenating raw byte sequence payloads (RBPS). In the case of partitioned data, each RBPS may contain only one partition type. For the purpose of the present invention, the NAL units are illustrated as having been encoded in an exemplary transmission layer using real time protocol (RTP). Other protocols such as MPEG-2 Transport, MPEG-2 Program Stream and H.233 may also be used.

In FIG. 3A, an RTP packet stream includes an RTP header and a single NAL unit. The RTP header (or packetized elementary stream (PES) headers for MPEG-2) conveys information about the encryption method. The NAL unit includes an NAL header (see definition infra) and a RBSP payload. The RBSP packet of the NAL unit may contain partition type A data, partition type B data or partition type C data.

In FIG. 3B, an RTP packet stream includes an RTP header and multiple NAL units. The first NAL unit (NAL unit 1) contains information about the encryption method. Each NAL unit includes an NAL header (see definition infra) and RBSP payloads. The RSBP packet of NAL unit 1 contains supplemental enhancement information (SEI) information (syntax=reserved_SEI_message). Reserved_SEI_message includes information about the encryption of NAL units 2 through N. The format of reserved_SEI_message must be agreed upon by both sender and receiver, so the receiver knows how to interpret the SEI message. The RBSP packet of NAL unit 2 contains partition type A data, the RBSP packet of NAL unit 3 contains partition type B data and the RBSP packet of NAL unit 4 contains partition type C data. Any NAL unit 2 through N may contain a partition type A RBSP, a partition type B RBSP or a partition type C RBSP, but only one.

FIG. 4 is an illustration of the field structure of a NAL unit. In FIG. 4, a NAL unit includes a NAL header and a RBSP packet, which is a partition type A RBSP packet. The NAL header is defined as the group of fields forbidden_bit, nal_storage_idc and nal_unit_type. The nal_unit_type indicates whether the unit contains data for an A, B or C type partition. H.264 defines a hexadecimal value of nal_unit_type=0x2 indicates an A partition type, 0x3 indicates an B partition type and 0x3 indicates an C partition type Other fields in the header are as illustrated. The RBSP packet contains a slice header field (syntax=slice_header), a slice ID field (syntax=slice_id), a slice data field (syntax=slice_data) and a trailing bits field (syntax=trailing_bits). The slice header field is included only when the NAL unit contains a partition type A RBSP. Partition type B and C RBSPs contain only the slice ID field, the slice data field and the trailing bits field. The slice data field contains header, intra or inter data as discussed supra.

The slice header includes several fields, the most relevant to the present invention being a frame number field (syntax=frame_number), a picture structure field (syntax=picture_structure) and a slice type field (syntax=slice_type_idc). The picture structure field indicates if the data is field data or frame data. A frame is defined as containing sampled and quantized luma and chroma data of all rows of a picture. A frame consists of two fields, a top field and a bottom field. A field is defined as an assembly of alternate rows of a frame. The slice type field indicates if the slice is a P, B, I, SP or SI slice.

FIG. 5 is a schematic block diagram of a system for encrypting the ITU-T H.264 video data stream according to the present invention. In FIG. 5, an encryption device 100 includes a H.264 encoder 105, an analyzer 110, a control interface 115, an encryption controller 120, a switch 125, encryptors 130A, 130B and 130C and key generators 135A, 135B and 135C.

H.264 encoder 105 receives input video data stream 140 and generates compressed video data stream 145. Compressed video data stream 145 is formatted in NAL units, each of which incorporates one of either an A type partition, a B type partition or a C type partition as illustrated in FIGS. 3 and 4 and describe supra. Analyzer 110 analyzes compressed video data stream 145 by reading the NAL headers to obtain, for example, coding information as to the type of partition (A, B, C) the NAL unit contains, or storage of the corresponding picture in the reference picture buffer. The collected information is passed to encryption controller 120 via a statistics signal 150. Encryption controller 120 compares the statistics on each NAL unit to a set of selection and encryption rules generated by control interface 115, and selects which NAL units will be encrypted and how they will be encrypted via an encryptor control signal 155 sent to switch 125 and a key selection signal 160 sent to key generators 135A, 135B and 135C.

Selection and encryption rules may be global (i.e. partition based) wherein the NAL values of unit parameters nal_unit_type and slice_type_idc define what type of partition to encrypt or selection and encryption rules may be local (i.e. based on attributes other than partition type). A local selection and encryption rule must always have a global selection and encryption rule associated with it. Local selection rules allow only selected NAL units of the globally selected partition type to be selected and encrypted. Local selection and encryption rules may be based on any non-partition type related field in the NAL unit. For example, local selection and encryption rules may be based on the number of bits in the slice data field (syntax=slice_data).

Control interface 115 can implement a fixed set of selection and encryption rules or a programmable set of selection and encryption rules for encryption controller 120 to apply to the information about a particular NAL unit obtained from statistics signal 150. Programmable rules allow the user to dynamically adjust the selection rules, possibly taking into account information external to video data stream 140.

The selected encryptor (either encryptor 130A, 130B or 130C) encrypts the entire NAL unit or a portion of the NAL unit. For example, the NAL header or one or more fields within the NAL header, the RBPS field or one or more sub-fields within the RBSP field (for example the slice data field) or just selected groups of bits with the NAL unit may be encrypted. When the NAL unit header is encrypted, the corresponding RBSP is not be encrypted, thus saving encryption time. If an RBSP is encrypted, the corresponding NAL unit header is not encrypted and the NAL unit header conveys information needed for decryption of the RBSP. For example, the sender and receiver agree upon an encryption method for a particular partition type and the partition type is described in the NAL header field nal_unit_type.

Similarly, encryption information may be contained in the NAL header or one or more fields within the NAL header, the RBPS field or one or more sub-fields within the RBSP field. The example of the reserved_SEI_message field of the RBSP packet was illustrated in FIG. 3B and described supra. Almost any other fields of the NAL unit may be used (for example, the trailing_bits field) by “misusing” those fields.

The output of switch 125 is a selectively encrypted video data signal 165.

Three encryptors 130A, 130B, and 130C are illustrated in FIG. 5. In a first exemplary implementation, each encryptor 130A, 130B and 130C is respectively dedicated to a different partition type, i.e. A type, B type or C type. In a second exemplary implementation, each encryptor 130A, 130B and 130C is dedicated to a different type of encryption method in both the generic sense and the specific sense. Examples of generic encryption methods include variable key, fixed key, single encryption, double encryption methods. In the case of double encryption, two encryptors would be cascaded within one of encryptors 130A, 130B or 130C. Examples of common specific encryption methods include the Data Encryption Standard (DES), the triple DES (3DES), the Advanced Encryption standard (AES) and the Digital Video Broadcast-Common Scrambling Algorithm (DVB-CSA).

Similarly, each encryptor 130A, 130B or 130C may be supplied with its own respective key generator 135A, 135B or 135C or each key generator may be available to each encryptor. There may be more or less than three encryptors, there may be more or less than three key generators and the number of encryptors need not be the same as the number of key generators. Table 1 lists several examples of encryption policy, the key NAL unit parameter and the rationale and benefit of that policy.

TABLE I

| Policy | | | | |
|---|---|---|---|---|
| | Partitions | | | |
| Partitions | not | Encryption | | |
| encrypted | encrypted | method | NAL unit | Benefit |
| B and C | A | any | nal_unit_type | Enable |
| | | | | analysis of |
| | | | | headers |
| A | B and C | any | nal_unit_type | Protection |
| | | | | with least |
| | | | | effort (i.e. |
| | | | | software) |
| A | | Variable key | nal_unit_type | Unequal |
| | | | | protection |
| B and C | | Fixed key | | |
| A | | Double | nal_unit_type | Unequal |
| | | encrypt | | protection |
| B and C | | Single | | |
| | | encrypt | | |
| A | B and C | any | nal_unit_type | Protecting |
| | | | | only I or |
| | | | slice_type_idc | SP slices |

When data partitioning is used, the important low-level data in a packet is concentrated in certain partitions rather than being mixed with other data and scattered throughout the packet. Hence, by choosing to encrypt a certain partition in a packet and by which encryption method, a certain level of protection can be obtained. For example, encrypting the high level information (e.g. partition type A) will make the whole packet practically undecodable, while encrypting lower level information (e.g. partition types B and C), the packet may be decoded, but at a lower quality.

Different strategies are conceivable for implementing this principle. These strategies can take into account size and significance of partitions, depending on the application. For example, when encoding video with the intention to distribute it in band width-limited or error prone environments such as the Internet or ad-hoc wireless networks, a higher number of intra macro-blocks can be deliberately used to reduce the risk or error propagation. (As defined supra, intra macro-block can be decoded independently and is not used for decoding inter macro-blocks.) In such cases, it is useful to encrypt the partitions containing intra data (e.g. partition type B), i.e. I and SI frames, even though such partitions can contain more bits than other partitions Another example is encryption of partitions encompassing inter data (e.g. partition type C) in inter coded frames, i.e. P, B, and SP frames.

FIG. 6 is a flowchart of the method steps for encrypting video data according to the present invention. In step 170, video data is grouped into slices as illustrated in FIG. 1 and described supra. In step 175, the grouped video data is partitioned into A type partitions, B type partitions and C type partitions as illustrated in FIG. 2 and described supra. In step 180, the partitioned data is encoded according to ITU-T H.264 standards as illustrated in FIGS. 3 and 4 and described supra. In step 185, a NAL unit is selected and its partition type (A, B or C) determined based on the parameter nal_unit_type in the NAL header of all NAL units or alternatively based on the parameter nal_unit_type and the parameter slice_type_idc found in the slice header field of NAL units containing partition type A RBSPs. In step 190, it is determined whether or not to encrypt a particular NAL unit based on selection and encryption rules as discussed supra in reference to FIG. 5. If the NAL unit is not to be encrypted, then the method loops to step 185 and the next NAL unit in the data stream is selected. If the NAL unit is to be encrypted, then the method proceeds to step 195. In step 195, the encryption method and encryption key are selected and in step 200 the NAL unit or portion of the NAL unit is encrypted. The method then loops to step 185 where the next NAL unit is selected.

The description of the embodiments of the present invention is given above for the understanding of the present invention. It will be understood that the invention is not limited to the particular embodiments described herein, but is capable of various modifications, rearrangements and substitutions as will now become apparent to those skilled in the art without departing from the scope of the invention. Therefore, it is intended that the following claims cover all such modifications and changes as fall within the true spirit and scope of the invention.

1. A method of encrypting a video data stream, said video data stream partitioned into units based upon a type of data contained within said units, comprising:
determining for each unit the type of data contained within said unit; and
encrypting a particular unit or a portion of said particular unit based upon the type of data contained within said unit.

2. The method of claim 1, wherein said type of data is data selected from the group consisting of header data, intra data and inter data.

3. The method of claim 2, wherein said intra data is selected from the group consisting of I block data and SI block data and wherein said inter data is selected from the group consisting of P block data, B block data and SP block data.

4. The method of claim 1, further including excluding a particular unit from encryption based upon the type of data contained within said particular unit.

5. The method of claim 1, wherein each unit containing the same type of data is always encrypted.

6. The method of claim 1, wherein each unit containing the same type of data is encrypted identically.

7. The method of claim 1, wherein units containing different types of data are encrypted using different encryption methods, different encryption keys or both different encryption methods and different encryption keys.

8. A method of encrypting a video data stream, said video data stream partitioned into NAL units formed from partitioned slices, each NAL unit containing either header data, intra data or inter data, comprising:
determining for each NAL unit whether the NAL unit contains header data, intra data or inter data; and
encrypting a particular NAL unit or a portion of said particular NAL unit based upon whether said particular NAL unit contains header data, intra data or inter data.

9. The method of claim 8, wherein said intra data is selected from the group consisting of I block data and SI block data and wherein said inter data is selected from the group consisting of P block data, B block data and SP block data.

10. The method of claim 8, further including excluding a particular unit from encryption based upon the type of data contained within said particular unit.

11. The method of claim 8, wherein each NAL unit containing header data is not encrypted or encrypted identically, each NAL unit containing intra data is not encrypted or encrypted identically, and each NAL unit containing inter data is not encrypted or encrypted identically.

12. The method of claim 8, wherein at least two types of NAL units selected from the group of NAL unit types consisting of NAL units containing header data, NAL units containing intra data and NAL units containing inter data are encrypted using, for each type of NAL unit, different encryption methods, different encryption keys or both different encryption methods and different encryption keys.

13. The method of claim 8, wherein said portion of said particular NAL unit to be encrypted is selected from the group consisting of NAL headers, one or more fields within said NAL headers, RBSP fields, one or more sub-fields within said RBSP fields and selected groups of bits within said NAL unit.

14. The method of claim 8, further including embedding decryption information in NAL headers, in one or more fields within said NAL headers, in RBSP fields, in one or more sub-fields within the RBSP fields or in selected groups of bits within said NAL unit.

15. A system for encrypting a video data stream, said video data stream partitioned into units based upon a type of data contained within said units comprising:
means for determining for each unit the type of data contained within said unit; and
means for encrypting a particular unit or a portion of said particular unit based upon the type of data contained within said unit.

16. The system of claim 15, wherein said type of data is selected from the group consisting of header data, intra data and inter data.

17. The system of claim 16, wherein said intra data is selected from the group consisting of I block data and SI block data and wherein said inter data is selected from the group consisting of P block data, B block data and SP block data.

18. The system of claim 15, further including means for not encrypting a particular unit based upon the type of data contained within said unit.

19. The system of claim 15, wherein said means for encrypting is adapted to always encrypt units containing the same type of data.

20. The system of claim 15, wherein said means for encrypting is adapted to identically encrypt all units containing the same type of data.

21. The system of claim 15, wherein said means for encrypting is adapted to encrypt units containing different types of data by different encryption methods, different encryption keys or both different encryption methods and different encryption keys.

22. A system of encrypting a video data stream, said video data stream partitioned into NAL units formed from partitioned slices, each NAL unit containing either header data, intra data or inter data, comprising:
means for determining for each NAL unit whether the NAL unit contains header data, intra data or inter data; and
means for encrypting a particular NAL unit or a portion of said particular NAL unit based upon whether said particular NAL unit contains header data, intra data or inter data.

23. The system of claim 22, wherein said intra data is selected from the group consisting of I block data and SI block data and wherein said inter data is selected from the group consisting of P block data, B block data and SP block data.

24. The system of claim 22, wherein said means for encrypting is adapted to exclude a particular unit from encryption based upon the type of data contained within said particular unit.

25. The system of claim 22, wherein said means for encrypting is adapted to not encrypt or to identically encrypt each NAL unit containing header data or is adapted to not encrypt or to identically encrypt each NAL unit containing intra data, and is adapted to not encrypt or to identically encrypt each NAL unit containing inter data.

26. The system of claim 22, wherein said means for encrypting is adapted to encrypt at least two types of NAL units selected from the group of NAL unit types consisting of NAL units containing header data, NAL units containing intra data and NAL units containing inter data using, for each type of NAL unit, different encryption methods, different encryption keys or both different encryption methods and encryption keys.
